(19) United States
(12) Patent Application Publication
(10) Pub. No.: US 2007/0235418 A1
(43) Pub. Date: Oct. 11, 2007

(54) Method for cutting substrate and substrate cutting apparatus using the same

(75) Inventors: Myung-il Park, Daejeon-si (KR); Kyung-seop Kim, Suwon-si (KR); Yong-eui Lee, Seongnam-si (KR); Dong-chin Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/590,308

(22) Filed: Oct. 31, 2006

(30) Foreign Application Priority Data
Mar. 28, 2006 (KR) 10-2006-0028050

(51) Int. Cl. B23K 26/00

(52) U.S. Cl. 219/121.6

(57) ABSTRACT

A substrate cutting method and a substrate cutting apparatus cut a substrate by simultaneously irradiating at least two laser beams having different wavelengths onto top and bottom surfaces of the substrate. The substrate cutting method includes preparing a mother substrate assembly having a thin film transistor (TFT) mother substrate and a color filter mother substrate, focusing at least two laser beams onto at least two different locations spaced apart from each other on a perpendicular relative to a surface of the mother substrate assembly simultaneously, and cutting the mother substrate assembly by the at least two different focused locations.

This application claims priority from Korean Patent Application No. 10-2006-0028050 filed on Mar. 28, 2006 in the Korean Intellectual Property Office, the disclosure of which is incorporated herein by reference in its entirety.

### BACKGROUND OF THE INVENTION

1. Field of the Invention

The present invention relates to a substrate cutting method and a substrate cutting apparatus using the same, and more particularly to a substrate cutting method simultaneously irradiating at least two laser beams having different wavelengths onto top and bottom surfaces of the substrate, and a substrate cutting apparatus using the same.

2. Description of Related Art

Liquid crystal displays (LCDs) have been widely used.

A liquid crystal display (LCD) includes a thin film transistor (TFT) substrate having a plurality of gate and data lines, switching devices formed at intersections of the gate lines and the data lines, and pixel electrodes connected to the switching devices. The LCD further includes a color filter substrate opposingly connected to the TFT substrate and having RGB color filters and a common electrode. A liquid crystal layer is interposed between the TFT substrate and the color filter substrate.

Manufacture of such an LCD includes a substrate cutting process. A TFT mother substrate including a plurality of TFT substrates, and a color filter mother substrate including a plurality of color filter substrates are combined to produce a mother substrate assembly, which is cut into liquid crystal cell units. Among conventional substrate cutting methods, cutting methods using a diamond wheel or a CO₂ laser beam have been widely used. However, in the cutting method using the diamond wheel, the cutting process may result in damage such as breaking. In addition, additional processes, e.g., grinding a cut surface, may be needed. Further, when the mother substrate assembly is cross cut, misalignment may occur. In the cutting method using the CO₂ laser beam, since the surface of the mother substrate assembly is heated to a high temperature, a peeling phenomenon may occur on the surface of the mother substrate assembly, thereby preventing vertical cracks from being generated and making it difficult to properly cut the mother substrate assembly.

Therefore, a need exists for a system and method for cutting a substrate without a further process after cutting.

### SUMMARY OF THE INVENTION

According to an embodiment of the present invention, a substrate cutting method includes preparing a mother substrate assembly having a thin film transistor (TFT) mother substrate and a color filter mother substrate, focusing at least two laser beams onto at least two different locations spaced apart from each other on a perpendicular relative to a surface of the mother substrate assembly simultaneously, and cutting the mother substrate assembly by the at least two different focused locations.

According to another embodiment of the present invention, a substrate cutting apparatus includes a laser beam generator generating at least two laser beams, a condensing portion condensing the at least two laser beams generated from the laser beam generator into a condensed laser beam, and a focusing lens focusing the condensed laser beam onto a predetermined area of a mother substrate assembly.

### BRIEF DESCRIPTION OF THE DRAWINGS

The present invention will become more apparent by describing in detail preferred embodiments thereof with reference to the attached drawings in which:

FIG. 1 is a flowchart illustrating processing steps of a method of manufacturing a liquid crystal display apparatus according to an embodiment of the present invention;

FIG. 2 is a flowchart illustrating a method of cutting a substrate according to an embodiment of the present invention in the liquid crystal cell process shown in FIG. 1;

FIG. 3 is a schematic diagram of a substrate cutting apparatus according to an embodiment of the present invention;

FIG. 4 is a sectional view of the focusing lens shown in FIG. 3;

FIGS. 5A and 5B illustrate processing steps of a method of cutting a substrate using the substrate cutting apparatus shown in FIG. 3; and

FIG. 6 is a sectional view taken along a line □-□′ of FIGS. 5A and 5B.

### DETAILED DESCRIPTION OF PREFERRED EMBODIMENTS

The present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, embodiments are provided so that this disclosure will be thorough and complete and will fully convey the concept of the invention to those skilled in the art. Like reference numerals refer to like elements throughout the specification.

The present invention will how be described more fully with reference to the accompanying drawings, in which exemplary embodiments of the invention are shown.

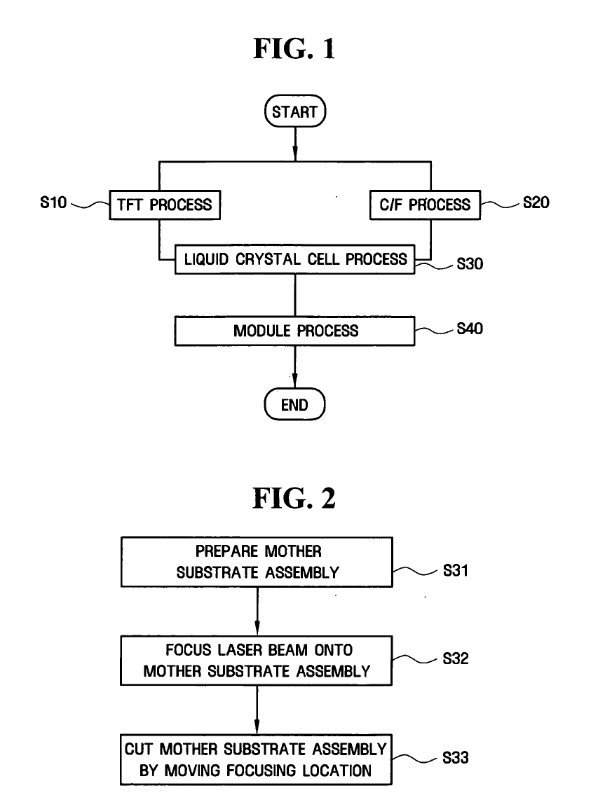

A method of manufacturing a liquid crystal display (LCD) according to an embodiment of the present invention will be described with reference to FIGS. 1 and 2. FIG. 1 is a flowchart illustrating a method of manufacturing a liquid crystal display (LCD) according to an embodiment of the present invention.

Referring to FIG. 1, the method of manufacturing the LCD includes a thin film transistor (TFT) process SO, a color filter (C/F) process S20, a liquid crystal cell process S30 and a module process S40,

The TFT process S10 includes manufacturing a plurality of thin film transistor substrates on a mother substrate, and may include, for example, repeatedly performing thin film formation, evaporation, photolithography, and etching.

The C/F process S20 includes manufacturing a plurality of color filter substrates on a mother substrate, and may include, for example, repeatedly performing of thin film formation, evaporation, photolithography, and etching, as in the TFT process S10. The TFT process S10 and the C/F process S20 may further include a checking process and a cleaning process performed before/after the thin film formation, the evaporation, the photolithography, or the etching.

The liquid crystal cell process S30 includes injecting liquid crystals between the thin film transistor (TFT) mother substrate and the color filter mother substrate, and may include combining the two mother substrates, and cutting the resultant product.

In the combining and cutting, the TFT mother substrate and the color filter mother substrate are combined within an allowed alignment margin and the combined resultant product is cut into liquid crystal cell units. The cutting may be performed using at least two laser beams having different wavelengths.

Hereinafter, a substrate cutting method will be described with reference to FIG. 2 in more detail.

FIG. 2 is a flowchart illustrating a substrate cutting method according to an embodiment of the present invention in the liquid crystal cell process shown in FIG. 1.

Referring to FIG. 2, the substrate cutting method includes multiple processes including, for example, preparing a mother substrate assembly S31, focusing a laser beam onto the mother substrate assembly S32, and cutting the mother substrate assembly while moving focused on locations S33.

Preferably, these operations are performed sequentially.

As described above, the preparation of a mother substrate assembly S31 includes combining the TFT mother substrate having a plurality of TFT substrates formed thereon and the color filter mother substrate having a plurality of color filter substrates formed thereon to yield a mother substrate assembly. The mother substrate assembly includes a plurality of liquid crystal cells. A predetermined alignment mark may made on each of the liquid crystal cells for use in cutting the mother substrate assembly.

A laser beam is focused onto the mother substrate assembly S32, wherein at least two laser beams are simultaneously focused on two or more different perpendicularly spaced locations of the mother substrate assembly.

The laser beams used may be first and second laser beams have different wavelengths. The first and second laser beams are focused respectively onto at least two different locations of the mother substrate assembly, the at least two different locations being spaced apart from each other on a perpendicular of the mother substrate assembly.

If the first laser beam has a shorter wavelength than the second laser beam, the first laser beam is focused on a top surface of the mother substrate assembly while the second laser beam is focused on a bottom surface of the mother substrate assembly. The bottom surface of the mother substrate assembly is perpendicularly spaced apart from a focused location of the first laser beam. The refractive index of a laser beam may vary depending on the wavelength of the laser beam, so that the focused location of the laser beam varies accordingly. In a case where the first laser beam has a shorter wavelength than the second laser beam, the first laser beam experiences a greater refractive index than the second laser beam, and the first laser beam is refracted to a greater degree than the second laser beam is, so that the first laser beam is focused on the top surface of the mother substrate assembly.

A focus spot of the laser beam focused on the mother substrate assembly is moved to cut the mother substrate assembly S33. The substrate cutting apparatus moves the focus spot of the laser beam in at least two directions to cut the mother substrate assembly. The focus spot is moved by moving one or both of the laser beam and the mother substrate assembly.

The laser beam focused on two different locations of the mother substrate assembly by the substrate cutting apparatus is moved from the focus spot in a first direction substantially parallel with one side of the mother substrate assembly, in a longitudinal direction of the mother substrate assembly. Subsequently, the laser beam is moved from a focus spot in a second direction substantially parallel with another side of the mother substrate assembly, the another side being substantially perpendicular to the one side of the mother substrate assembly, e.g., in a transverse direction.

As described above, first and second laser beams having different wavelengths may be used as the laser beam. The first and second laser beams are simultaneously focused onto top and bottom surfaces of the mother substrate assembly to then be used in simultaneously cutting the top and bottom surfaces of the mother substrate assembly. While the illustrative embodiment has shown that the mother substrate assembly is cut by moving the focus spot of the laser beam first in the first direction by way of example, the invention is not limited thereto and can be applied to a case of moving the focus spot of the laser beam first in a second direction, or simultaneously in the first and second directions. The mother substrate assembly may be cut by a predetermined unit, for example, by a liquid crystal cell unit. The mother substrate assembly cut by a liquid crystal cell unit may be further subjected to a cutting process. For example, the mother substrate assembly may be subjected to a cutting process such that a predetermined portion of the color filter substrate is cut to expose a predetermined area of the TFT substrate, which corresponds to a cutting process performed for the purpose of exposing the predetermined area of the TFT substrate and attaching modules, such as gate and data drivers, to the liquid crystal cell. To this end, as described above, laser beams having different wavelengths may be used. In addition, the color filter substrate cutting process may be performed before the process of cutting the mother substrate assembly, that is, after the process of combining the TFT mother substrate and the color filter mother substrate with each other.

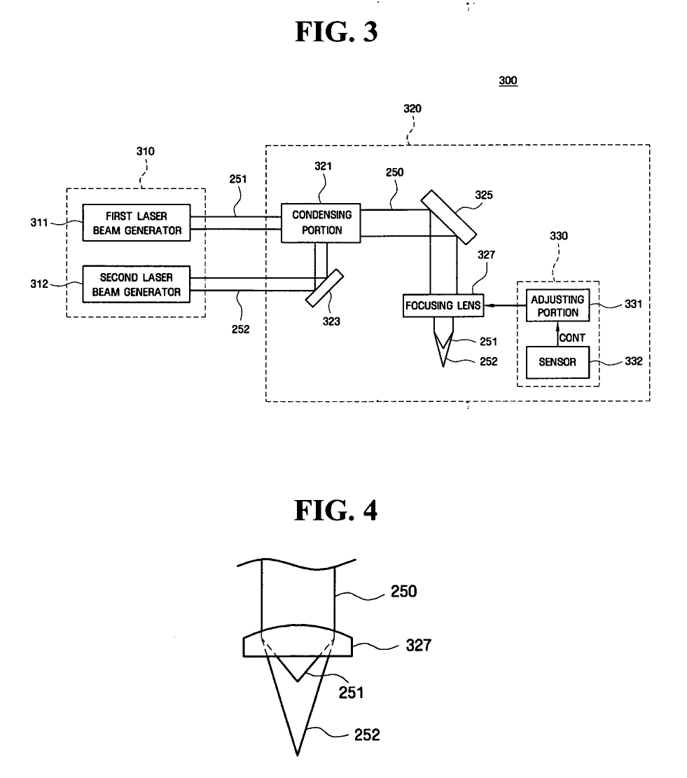

A substrate cutting method using the laser beam and a substrate cutting apparatus using the substrate cutting method will be described with reference to FIGS. 3 through 6. The liquid crystal panel manufactured in the liquid crystal cell process S30 and the other modules are combined in the module process S40, thereby completing the LCD.

While the LCD manufacturing method has been described by way of example, the invention is not limited thereto, and it should be noted that it will be obvious to those skilled in the art that many variations and modifications can be made to preferred embodiments described herein without substantially departing from the principles of the present invention.

Hereinafter, a substrate cutting apparatus and a substrate cutting method using the laser beams described above will be described in more detail with reference to FIGS. 3 through 6.

FIG. 3 is a schematic diagram of a substrate cutting apparatus according to an embodiment of the present invention, and FIG. 4 is a sectional view of the focusing lens shown in FIG. 3.

Referring to FIG. 3, a substrate cutting apparatus 300 includes a laser beam generating unit 310 and a laser beam focusing unit 320.

The laser beam generating unit 310 includes a first laser beam generator 311 and a second laser beam generator 312. The laser beam focusing unit 320 may include a condensing portion 321, mirrors 323 and 325, a focusing lens 327, and a focus adjusting unit 330.

The first and second laser beam generators 311 and 312 generate first and second laser beams 251 and 252 having different wavelengths, respectively. The first and second laser beams 251 and 252 may be, for example, laser beams having short wavelengths exhibiting good absorbance with respect to a glass substrate.

The first laser beam 251 and the second laser beam 252 may be, for example, Nd:YAG laser beams. The first laser beam 251 may have a wavelength in a range of about 260 to about 270 nm, and the second laser beam 252 may have a wavelength in a range of about 350 to about 360 nm. Similarly, the first laser beam 251 and the second laser beam 252 may be, for example, femto-second laser beams. The wavelength of the first laser beam 251 is in a range of about 350 to about 450 nm, and the wavelength of the second laser beam 252 is in a range of about 750 to about 850 nm. Where the wavelength of the first laser beam 251 is shorter than that of the second laser beam 252, the first laser beam 251 experiences a relatively higher refractive index than the second laser beam 252. Thus, the focal distance of the first laser beam 251 is shorter than that of the second laser beam 252.

Each of the first and second laser beam generators 311 and 312 may also include a shutter (not shown) for increasing the intensity or efficiency of the first and second laser beams 251 and 252, and a beam expender (not shown) for expanding a width of each of the first and second laser beams 251 and 252.

The laser beam focusing unit 320 includes first and second mirrors 323 and 325, a condensing portion 321, a focusing lens 327, and a focus adjusting unit 330. The second mirror 325 directs the laser beam 250 toward the focusing lens 327. The condensing portion 321 condenses first and second laser beams 251 and 252 into one laser beam 250. The focusing lens 327 focuses the condensed laser beam 250 onto a machining unit. The focus adjusting unit 330 adjusts a focus spot of the focusing lens 327.

The first mirror 323 changes the direction of the second laser beam 252 received from the second laser beam generator 312, and transfers the second laser beam 252 to the condensing portion 321. The first mirror 323 may have a predetermined material coated on its surface. The first mirror 323 directs the second laser beam 252 toward the condensing portion 321, so that the second laser beam 252 is transferred to the condensing portion 321.

The condensing portion 321 receives the first laser beam 251 and the second laser beam 252 from the first laser beam generator 311 and the second laser beam generator 312 via the first mirror 323, respectively, and condenses the first and second laser beams 251 and 252 into the laser beam 250.

The second mirror 325 changes the direction of the laser beam 250, which has passed through the condensing portion 321, to direct it toward the focusing lens 327. The second mirror 325 may be devised to transmit only a laser beam having a desired wavelength by coating a predetermined material on its surface. In an alternative embodiment, the second mirror 325 may have pin holes formed therein.

The focusing lens 327 focuses the laser beam 250 transferred via the second mirror 325 onto a machining unit. Here, the focusing lens 327 focuses the first and second laser beams 251 and 252 having different wavelengths onto the same location of the machining unit.

The focusing lens 327 will-be described in detail with reference to FIG. 4. Referring to FIG. 4, the focusing lens 327 has a convex portion. The focusing lens 327 focuses the first and second laser beams 251 and 252 having different wavelengths onto the same location of the machining unit. Where the first laser beam 251 of a relatively short wavelength experiences a relatively large refractive index, it passes through the focusing lens 327 and is focused relatively close to the focusing lens 327, for example, at a top surface of the machining unit. By contrast, since the second laser beam 252 of a relatively long wavelength experiences a relatively small refractive index, it passes through the focusing lens 327 and is focused relatively far from the focusing lens 327, for example, at a bottom surface of the machining unit. The first laser beam 251 and the second laser beam 252 may be focused on the same location of the machining unit, that is, at the same location perpendicular to the machining unit. The focusing lens 327 may be, for example, a plano-convex lens. The machining unit may be a mother substrate assembly.

Referring to FIG. 3, the substrate cutting apparatus 300 may further include a focus adjusting unit 330. The focus adjusting unit 330 adjusts the position of the focusing lens 327 using a predetermined control signal CONT, thereby controlling the focus spots of the first and second laser beams 251 and 252. The focus adjusting unit 330 may include a sensor 332 and an adjusting portion 331.

The sensor 332 receives the first and second laser beams 251 and 252 reflected from a machining unit, e.g., a mother substrate assembly, to generate the predetermined control signal CONT. In a case where focus spots of the first and second laser beams 251 and 252 are changed due to different flatnesses of the surface of a mother substrate assembly, or movement of a cutting apparatus or a mother substrate assembly during a substrate cutting process, the sensor 332 generates the control signal CONT. The control signal CONT is used to read the first and second laser beams 251 and 252 reflected from the mother substrate assembly and to adjust the position of the focusing lens 327 according to the read result. The sensor 332 may be light-receiving elements of the first and second laser beams 251 and 252, for example, photodiodes.

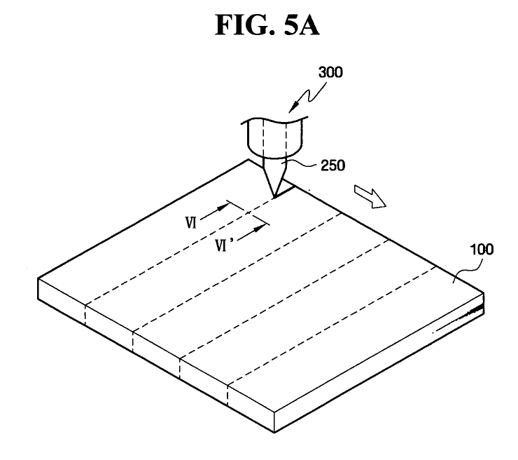

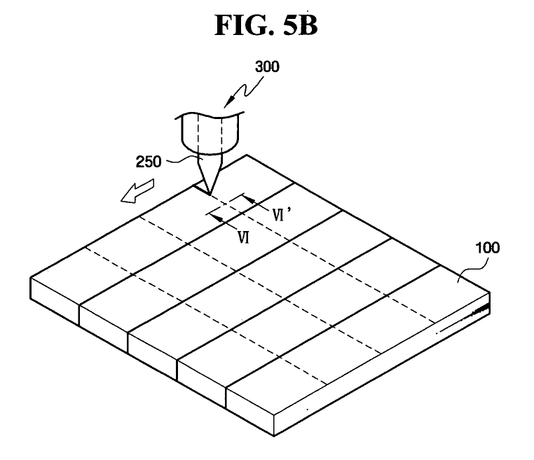

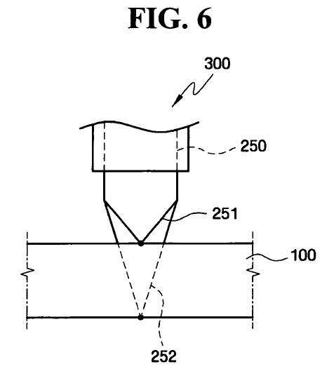

The adjusting portion 331 adjusts focus spots of focusing lens 327 up and down in response to the control signal CONT supplied from the sensor 332. Accordingly, the focus spots of the first and second laser beams 251 and 252 irradiated onto the mother substrate assembly during a cutting process can be maintained at the same location relative to the mother substrate assembly. Hereinafter, the substrate cutting method using a substrate cutting apparatus will be described in detail with reference to FIGS. 5A and 6.

FIGS. 5A and 5B illustrate processing steps of a method of cutting a substrate using the substrate cutting apparatus shown in FIG. 3, and FIG. 6 is a sectional view taken along a line □-□′ of FIGS. 5A-and 5B.

Referring to FIG. 5A, the substrate cutting method of the mother substrate assembly 100 is performed by focusing a laser beam 250 generated from the substrate cutting apparatus 300 onto the mother substrate assembly 100.

The Iaser beam 250 supplied from the substrate cutting apparatus 300 is focused on a location on the mother substrate assembly 100, and the mother substrate assembly 100 is cut while repeatedly moving the laser beam 250 by a predetermined interval. The laser beam 250 focused on the mother substrate assembly 100 is moved in a first direction, e.g., in the longitudinal direction, substantially parallel with one side of the mother substrate assembly 100. Accordingly, the mother substrate assembly 100 is cut in the first direction.

The laser beam 250 may include at least two laser beams having different wavelengths, for example, first and second laser beams. Of the two laser beams, the laser beam having a shorter wavelength, e.g., the first laser beam, may be focused on the top surface of the mother substrate assembly 100, while the laser beam having a longer wavelength, e.g., the second laser beam, may be focused on the bottom surface of the mother substrate assembly 100. The bottom surface of the mother substrate assembly 100 is spaced apart from the top surface on the perpendicular thereof. This is because the refractive index the laser beam experiences may vary depending on the wavelength of the laser beam, so that the focused location of the laser beam varies accordingly. In a case where the first laser beam has a shorter wavelength than the second laser beam, it experiences a higher refractive index than the second laser beam. Thus, the first laser beam is focused on the top surface of the mother substrate assembly.

The first and second laser beams 250 focused on the mother substrate assembly will now be described in greater detail with reference to FIG. 6. Referring to FIG. 6, the laser beam 250, which is supplied from the mother substrate assembly 100, is a combination of laser beams having different wavelengths, e.g., first and second laser beams 251 and 252, which are simultaneously focused on the top and bottom surfaces of the mother substrate assembly 100. The first laser beam 251 has a shorter wavelength than the second laser beam 252. Accordingly, the first laser beam 251 is focused on the top surface of the mother substrate assembly 100, while the second laser beam 252 having the longer wavelength than the first laser beam 251 is focused on the bottom surface of the mother substrate assembly 100. The first laser beam 251 and the second laser beam 252 may be focused on the same location of the mother substrate assembly 100 on the perpendicular of the mother substrate assembly 100. A spot on the top surface of the mother substrate assembly 100 where the first laser beam 251 is focused and a spot on the bottom surface of the mother substrate assembly 100 where the second laser beam 252 is focused, are spaced apart from each other on the perpendicular of the mother substrate assembly 100.

The first and second laser beams 251 and 252 may be, for example, Nd:YAG laser beams or femto-second laser beams. In addition, while the illustrative embodiment has shown by way of example having two laser beams, the first and second laser beams, focused on top and bottom surfaces of the mother substrate assembly, the invention is not limited thereto, and it should be obvious to one skilled in the art that a plurality of laser beams may be focused on the top and bottom surfaces and the inside of the mother substrate assembly.

As described above, the mother substrate assembly 100 includes a combined mother substrate of a TFT mother substrate (not shown) having a plurality of TFT substrates and a color filter mother substrate (not shown) having a plurality of color filter substrates. The mother substrate assembly 100 may have alignment marks for cutting the combined mother substrate into liquid crystal cell units.

In the description above, it has shown that the mother substrate assembly 100 is cut in a first direction with reference to FIGS. 5A and 6. In the following description, a method of cutting the mother substrate assembly 100 in a second direction will now be described in greater detail with reference to FIG. 5B.

Referring to FIGS. 5B through 6, the method of cutting the mother substrate assembly 100 in the second direction mother substrate assembly 100 is also performed by focusing the laser beam 250 from the substrate cutting apparatus 300 onto the mother substrate assembly 100.

In a state in which the mother substrate assembly 100 cut in the first direction is aligned, the mother substrate assembly 100 is cut in the second direction. The substrate cutting apparatus 300 focuses the laser beam 250 onto a location of the top surface of the mother substrate assembly 166, which is to be cut in the second direction, and moves the laser beam 250 in the second direction substantially parallel with another side of the mother substrate assembly 100, e.g., in the transverse direction of the mother substrate assembly 100. Accordingly, the mother substrate assembly 100 is cut in the second direction.

The laser beams may be at least two laser beams having different wavelengths, e.g., the first and second laser beams 251 and 252, as shown in FIG. 6.

The mother substrate assembly 100 is cut into the liquid crystal cell units through processes shown in FIGS. 5A and 5B.

As described above, the substrate cutting method and apparatus according to the present invention have at least the following advantages.

Since a substrate is cut simultaneously from its upper and lower surfaces using at least two laser beams having different wavelengths, chipping or cracking can be suppressed.

Where the substrate is cut using the laser, it is not necessary to perform subsequent processes, e.g., an edge-grinding, a cleaning process, and the like, thereby reducing the number of processing steps and enhancing the manufacturing efficiency.

Further, since no physical cutting is done to the substrate, failures of the substrate, e.g., occurrence of a broken substrate, can be reduced.

Those skilled in the art will appreciate that many variations and modifications can be made to preferred embodiments without substantially departing from the principles of the present invention. Therefore, preferred embodiments of the invention are used in a generic and descriptive sense only and not for purposes of limitation.

What is claimed is:

1. A substrate cutting method comprising:
preparing a mother substrate assembly having a thin film transistor (TFT) mother substrate and a color filter mother substrate;
focusing at least two laser beams onto at least two different locations spaced apart from each other on a perpendicular relative to a surface of the mother substrate assembly simultaneously; and
cutting the mother substrate assembly by the at least two different focused locations.

2. The substrate cutting method of claim 1, wherein the cutting of the mother substrate assembly comprises:
moving the at least two different focused locations in a first direction substantially parallel with a first side of the mother substrate assembly; and
moving the at least two different focused locations in a second direction substantially parallel with a second side of the mother substrate assembly, the second side being substantially perpendicular to the first side of the mother substrate assembly.

3. The substrate cutting method of claim 2, further comprising moving, repeatedly, the at least two different focused locations by a predetermined interval in the first direction of the mother substrate assembly.

4. The substrate cutting method of claim 2, further comprising moving, repeatedly, the at least two different focused locations by a predetermined interval in the second direction of the mother substrate assembly.

5. The substrate cutting method of claim 1, wherein the focusing of the at least two laser beams comprises focusing a first laser beam at a top surface of the mother substrate assembly and simultaneously focusing a second laser beam having a longer wavelength than the first laser beam at a bottom surface of the mother substrate assembly, the bottom surface of the mother substrate assembly being spaced apart from the top surface relative to the perpendicular of the mother substrate assembly.

6. The substrate cutting method of claim 5, wherein the first and second laser beams are Nd:YAO laser beams, the first laser beam has a wavelength in a range of about 260 to about 270 nm, and the second laser beam has a wavelength in a range of about 350 to about 360 nm.

7. The substrate cutting method of claim 5, wherein the first and second laser beams are femto-second laser beams, the first laser beam has a wavelength in a range of about 350 to about 450 nm, and the second laser beam has a wavelength in a range of about 750 to about 850 nm.

8. The substrate cutting method of claim 1, wherein the cutting of the mother substrate assembly comprises cutting the mother substrate assembly into a liquid crystal cell unit.

9. The substrate cutting method of claim 1, further comprising cutting the color filter substrate of the mother substrate assembly to expose predetermined regions of the thin film transistor substrate.

10. A substrate cutting apparatus comprising:
a laser beam generator generating at least two laser beams;
a condensing portion condensing the at least two laser beams generated from the laser beam generator into a condensed laser beam; and
a focusing lens focusing the condensed laser beam onto a predetermined area of a mother substrate assembly.

11. The substrate cutting apparatus of claim 10, wherein the laser beam generator comprises:
a first laser beam generator generating a first laser beam; and
a second laser beam generator generating a second laser beam having a longer wavelength than the first laser beam.

12. The substrate cutting apparatus of claim 11, wherein the first and the second laser beams are Nd:YAG laser beams, the first laser beam has a wavelength in a range of about 260 to about 270 nm, and the second laser beam has a wavelength in a range of about 350 to about 360 nm.

13. The substrate cutting apparatus of claim 11, wherein the first and the second laser beam are femto-second laser beams, the first laser beam has a wavelength in a range of about 350 to about 450 nm, and the second laser beam has a wavelength in a range of about 750 to about 850 nm.

14. The substrate cutting apparatus of claim 10, wherein the focusing lens focuses the first and second laser beams having different wavelengths on at least two locations spaced apart from each other on a perpendicular of the mother substrate assembly.

15. The substrate cutting apparatus of claim 14, wherein the first laser beam has a greater refractive index than the second laser beam, the first laser beam is focused closer to the focusing lens than the second laser beam, the second laser beam is focused in a state in which it is spaced apart by a predetermined distance from a focused location of the first laser beam.

16. The cutting apparatus of claim 14, wherein the focusing lens is a plano-convex lens.

17. The cutting apparatus of claim 10, further comprising a focus adjusting unit for adjusting a focused location of the laser beam by adjusting the focus spot of the focusing lens.

18. The cutting apparatus of claim 17, wherein the focus adjusting unit comprises:
a sensor receiving the laser beam reflected from the mother substrate assembly and generating a predetermined control signal; and
an adjusting portion adjusting the focused location of the laser beam by adjusting the focusing lens up and down relative to the mother substrate assembly.
